(19) United States
(12) Patent Application Publication
(10) Pub. No.: US 2012/0221478 A1
(43) Pub. Date: Aug. 30, 2012

(54) TARGETED INFORMATION DISSEMINATION BASED ON AIRPORT GATE-SPECIFIC UTILIZATION

(75) Inventors: John G. Musial, Newburgh, NY (US); Sandeep R. Patil, Elmasford, NY (US); Abhinay R. Nagpal, Pune (IN); Carolyn A. Whitehead, Norwich, CT (US)

(73) Assignee: INTERNATIONAL BUSINESS MACHINES CORPORATION, Armonk, NY (US)

(21) Appl. No.: 13/036,180

(22) Filed: Feb. 28, 2011

(51) Int. Cl. G06Q 30/00

(52) U.S. Cl. 705/346

(57) ABSTRACT

Implementing targeted information dissemination based on gate-specific utilization includes collecting gate-specific utilization characteristics for an airport gate, the airport gate associated with a display device. Traveler data is collected for the airport gate and is aggregated. The implementation of targeted information dissemination includes identifying a pattern from aggregated traveler data, and disseminating information to the display device. The pattern is designated with an association with the information for dissemination.

### BACKGROUND

The present invention relates to information processing and dissemination, and more specifically, to targeted information dissemination based on airport gate-specific utilization.

At airports many passengers, especially children, watch the airplanes being attended to by the airport staff from the windows of their departure gates. There are various vehicles and devices that facilitate the fueling, loading of baggage, cleaning and general maintenance of each airplane at each gate. These supplementary vehicles that service each of the airplanes are associated with a particular airport gate for the duration of the time that they are in the act of servicing it. These vehicles move from gate to gate, as determined by the airport's schedule, continuously within the course of each day.

Similarly, there are also physical areas of every airport that would be considered ‘gate specific.’ These would include the immediate gate area itself (i.e., passenger seating area) as well as any walkways, hallways, aerobridges, etc. that funnel travelers to or from a specific gate.

Both the supplementary vehicles and the gate-specific areas of an airport could certainly ‘inherit’ the characteristics of a particular airport gate at a particular point in time and change dynamically as the gate characteristics change.

### SUMMARY

According to one embodiment of the present invention, a method for implementing targeted information dissemination based on gate-specific utilization is provided. The method includes collecting gate-specific utilization characteristics for an airport gate, the airport gate having an association with at least display device. The method also includes collecting traveler data for the airport gate, aggregating the traveler data, and identifying a pattern from aggregated traveler data, the pattern designated with an association with information for dissemination. The method further includes disseminating the information to the at least one display device.

According to a further embodiment of the present invention, a system for implementing targeted information dissemination based on gate-specific utilization is provided. The system includes a host system computer and an application executing the host system computer. The application is configured to implement a method. The method includes collecting gate-specific utilization characteristics for an airport gate, the airport gate having an association with at least display device. The method also includes collecting traveler data for the airport gate, aggregating the traveler data, and identifying a pattern from aggregated traveler data, the pattern designated with an association with information for dissemination. The method further includes disseminating the information to the at least one display device.

According to another embodiment of the present invention, a computer program product for implementing targeted information dissemination based on gate-specific utilization is provided. The computer program product includes a storage medium having instructions embodied thereon, which when executed by a computer cause the computer to implement a method. The method includes collecting gate-specific utilization characteristics for an airport gate, the airport gate having an association with at least display device. The method also includes collecting traveler data for the airport gate, aggregating the traveler data, and identifying a pattern from aggregated traveler data, the pattern designated with an association with information for dissemination. The method further includes disseminating the information to the at least one display device.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram depicting a system upon which targeted information processes may be implemented in exemplary embodiments;

FIG. 2 depicts a flow diagram illustrating a process in which targeted information may be implemented in exemplary embodiments; and

FIG. 3 depicts a database table with sample gate-specific utilization characteristics and traveler data gathered for an airport gate that may be utilized by the targeted information processes in exemplary embodiments.

### DETAILED DESCRIPTION

Targeted information dissemination processes are provided in accordance with exemplary embodiments. The targeted information dissemination processes collect gate-specific utilization characteristics of gates at an airport, as well as traveler data to identify patterns and determine what information to disseminate to a particular airport gate based upon these patterns and various rules configured for the targeted information processes. The gate-specific utilization characteristics and traveler data may be continuously collected and processed over time to produce the most up-to-date data concerning the travelers for use in selecting and then updating information disseminated at the gate based upon dynamically changing populations of travelers over time. In addition, the targeted information processes also identify one or more display devices associated with a particular airport gate for disseminating the information. In one exemplary embodiment, the information disseminated may be advertising that is tailored to a particular population of individuals at or near an airport gate. Alternatively, in another exemplary embodiment, the information disseminated may be suggestive or instructional type information that facilitates the flow of passengers to and from designated areas of the airport.

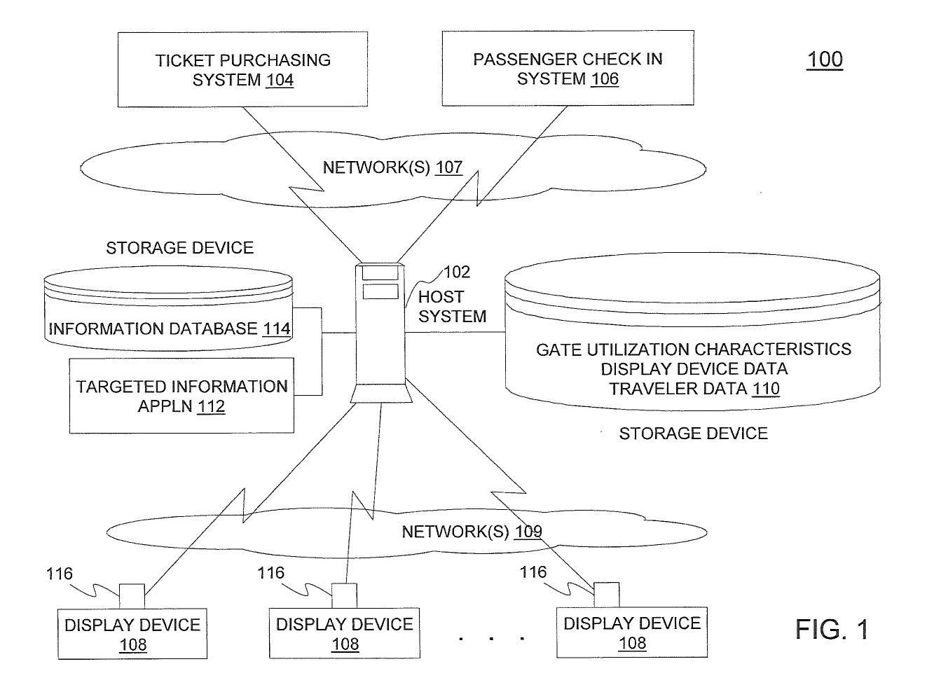

With reference now to FIG. 1, an exemplary system 100 upon which the targeted information dissemination processes may be implemented will now be described. In an exemplary embodiment, at least a portion of the system of FIG. 1 represents an airport. The system 100 includes a host system 102 in communication with a ticket purchasing system 104 and a passenger check in system 106.

The ticket purchasing system 104 represents a point of purchase system through which individuals purchase plane tickets. It will be understood that the ticket purchasing system 104 may reside within the airport of system 100 or it may be remotely located. For example, the ticket purchasing system 104 may include one or more airline websites through which individuals access flight information and procure airline tickets for travel with a desired airline. Alternatively, or in addition thereto, the ticket purchasing system 104 may comprise one or more secondary market agencies that compare airline ticket fees and supplemental fees as a service to customers shopping for best rates among multiple airline choices. Further, the ticket purchasing system 104 may comprise a physical establishment (brick and mortar), such as a travel agency or similar business. In an embodiment, the ticket purchasing system 104 provides ticket purchase information transacted between itself and its customers to the host system 102 as described herein.

The passenger check in system 106 represents a point of passenger check-in in preparation for boarding a plane. The passenger check in system 106 resides within the airport of the system 100 of FIG. 1. It will be understood that in some cases, the passenger check in system 106 may include the same functionality as the ticket purchasing system 104 (e.g., where a passenger purchases a ticket shortly before take-off), the airline ticket purchase and passenger check-in process may be handled by the same agent or at the same counter. The check-in process at the passenger check in system 106 tells the host system 102 that the passenger has arrived at the airport. This information regarding the passenger, as well as other data, is gathered at the passenger check in system 106 and provided to the host system 102 as will be described herein.

In an exemplary embodiment, the ticket purchasing system 104 and the passenger check in system 106 may each be implemented using a general-purpose computer executing a computer program for carrying out the processes described herein. Each of the ticket purchasing system 104 and the passenger check in system 106 may be a personal computer (e.g., a lap top, a personal digital assistant). If the ticket purchasing system 104 and/or the passenger check in system 106 is personal computers, the processing described herein may be shared by the systems 104 and/or 106 and the host system 102 (e.g., by providing an applet to the ticket purchasing system 104 and the passenger check in system 106). In one exemplary embodiment, one or both of the ticket purchasing system 104 and the passenger check in system 106 executes computer instructions for performing the targeted information processes described herein (via, e.g., a targeted information application 112). In another exemplary embodiment, as illustrated in FIG. 1, the host system 102 executes computer instructions for performing the targeted information processes (via, e.g., the targeted information application 112). The targeted information application 112 includes configurable rules that are applied to the data collected from the ticket purchasing system 104 and the passenger check in system for use in determining information for dissemination, as well as determining a selection of devices for presenting the information.

In an exemplary embodiment, the host system 102 is also in communication with display devices 108, e.g., over one or more networks 109. The host system 102 may be located within the airport or may reside in a remote location that is communicatively coupled to airport systems, such as the passenger system 106, the display devices 108, and the ticket purchasing system 104 (if resident in the airport). In an exemplary embodiment, a number of the display devices 108 may be statically located within or near a particular gate of the airport. That is, one display device 108 may be installed on a wall at a gate, or at a walkway that directly leads to the gate, or a food or retail establishment that services passengers in close proximity of the gate. In an exemplary embodiment, a number of the display devices 108 may be transient with respect to a particular gate. For example, a display device 108 may be disposed on a vehicle that services aircraft for multiple gates, such that the vehicle transporting the display device 108 moves from gate to gate pursuant to instructions provided by airport personnel.

In an exemplary embodiment, the display devices 108 comprise multimedia systems that include communication components which enable the display devices 108 to receive information from the host system 102 for presentation on the display devices 108 via, e.g., one or more networks 109, or from ticket purchasing system 104 and/or passenger check in system 106 via one or more networks 107 (e.g., if the targeted information application 112 is executing on the respective systems 104/106). The communication components include wireless transmission elements 116 (e.g., receiver, transceiver) that receives over-the-air information via the network(s) 109. The display devices 108 may comprise a VGA monitor, LCD, or similar type of display screen. Some of the display devices 108, e.g., those located within the gate area, may be equipped with a sound card to provide audio capabilities. In an exemplary embodiment, at least a portion of the display devices 108, particularly those that are transient, may be equipped with global positioning system (GPS) or other locating components such that the host system 102 may identify a precise location of the display devices 108 at any point in time. This information is useful in assisting the host system 102 in determining which display device 108 will receive specific information for an identified gate. These features are described further herein.

In an exemplary embodiment, the host system 102 is communicatively coupled to storage devices 110 and 114. The storage devices 110 and 114 may be implemented using a variety of devices for storing electronic information. It is understood that the storage devices 110 and 114 may be implemented using memory contained in the host system 102 or they may be separate physical devices (e.g., as shown in FIG. 1). The storage devices 110 and 114 are logically addressable as consolidated data sources across a distributed environment that includes network(s) 107 and/or 109. Information stored in the storage devices 110 and 114 may be retrieved and manipulated via the host system 102 and/or via the ticket purchasing system 104 and the passenger check in system 106. In one exemplary embodiment, the storage device 110 stores gate utilization information characteristics, display device data, and traveler data. The storage device 114 stores information for dissemination to one or more of the display devices 108.

In an exemplary embodiment, gate utilization information characteristics provide data concerning each physical gate within the airport of system 100. Each gate may be identified by a gate identifier (e.g., A1). For each gate identifier, utilization characteristics include the flight schedule which comprises flight numbers, flight arrival times and locations, and flight departure times and locations. As will be understood, this information is likely to be different each day and may itself change during the day (e.g., a flight delay or cancellation).

In an exemplary embodiment, display device data includes information identifying each display device (e.g., gate A1 display, or vehicle xyz display), as well as a transmission address that provides the communication path through which information is disseminated to the display device. This address may be an Internet Protocol-based address if the information is disseminated as digital packets over the networks. If different types of display devices 108 are implemented, the display device data may include characteristics of the display device that enable the host system 102 to format the information before it is disseminated to the display device.

In an exemplary embodiment, traveler data includes any data that can be collected about a passenger. For example, traveler data of interest may include frequent flyer miles acquired, passenger age, gender, and the number, ages and gender of other passengers traveling with the passenger, as well as checked baggage information (e.g., number of pieces of baggage and weight of baggage). This information may be collected from data acquired by the passenger check in system 106. Statistically, certain assumptions can be made about the number, ages, and gender of other passengers traveling with a passenger. For example, a passenger who purchases a single airline ticket and is over the age of 25 (and has optionally acquired a significant amount of frequent flyer miles) may be traveling on business. A passenger who purchases two airline tickets in which the ages of the passengers are close to one another may be traveling for pleasure with a significant other. Likewise, a passenger who purchases three or more tickets in total whereby at least one of the passengers is a youth may be traveling for pleasure with a family. Thus, this information may be aggregated for all passengers reporting to (or from) a particular gate for one or more flights to determine the nature or purpose of travel. Baggage information can also be used to determine what information will be disseminated (e.g., if the aggregated weight or number of pieces of checked baggage for passengers at a specified gate exceed a threshold value, the targeted information application 112 may be configured to provide useful information for passengers arriving at a specified gate to assist with baggage handling issues (e.g., baggage cart rental information, transportation options between gates, etc.). Business rules implemented via the targeted information application 112 may be applied to the aggregated information, as well as the gate utilization characteristics to determine what type of information will be disseminated to the passengers at or near the gate.

In one embodiment, gate utilization information may be used in conjunction with the traveler data to assist in evaluating a type or purpose of travel. For example, a couple traveling to Orlando or Las Vegas may be more likely to be traveling for pleasure than on business, while an individual traveling to Chicago or Minneapolis may be more likely to be traveling on business than for pleasure.

The network(s) 107 and 109 may be any type of known networks including, but not limited to, a wide area network (WAN), a local area network (LAN), a global network (e.g. Internet), a virtual private network (VPN), and an intranet. The networks 107 and 109 may be implemented using a wireless network or any kind of physical network implementation known in the art. For example, the display devices 108 may be coupled to the host system 102 through multiple networks (e.g., intranet and Internet). One or more of the display devices 108 and the host system 102 may be connected to the network 109 in a wireless fashion.

The host system 102 depicted in FIG. 1 may be implemented using one or more servers operating in response to a computer program stored in a storage medium accessible by the server. The host system 102 may operate as a network server (e.g., a web server) to communicate with the ticket purchasing system 104, passenger check in system 106, and display devices 108. The host system 102 handles sending and receiving information to and from the ticket purchasing system 104, passenger check in system 106, and display devices 108 and can perform associated tasks.

The host system 102 may also operate as an application server. As described above, the host system 102 may execute one or more computer programs to provide the targeted information processes, e.g., the targeted information application 112. Processing may be shared by the ticket purchasing system 104, passenger check in system 106, and the host system 102 by providing an application (e.g., java applet) to the ticket purchasing system 104 and/or the passenger check in system 106. Alternatively, the ticket purchasing system 104 or passenger check in system 106 can include stand-alone software applications for performing a portion or all of the processing described herein. As previously described, it is understood that separate servers may be utilized to implement the network server functions and the application server functions. Alternatively, the network server and the application server may be implemented by a single server executing computer programs to perform the requisite functions.

In one embodiment, the targeted information application 112 provides a user interface that enables users to configure the business rules, gate utilization characteristics (e.g., by way of flight schedules for each gate), display device data, and information for dissemination to be implemented. The information for dissemination is stored in storage device 114.

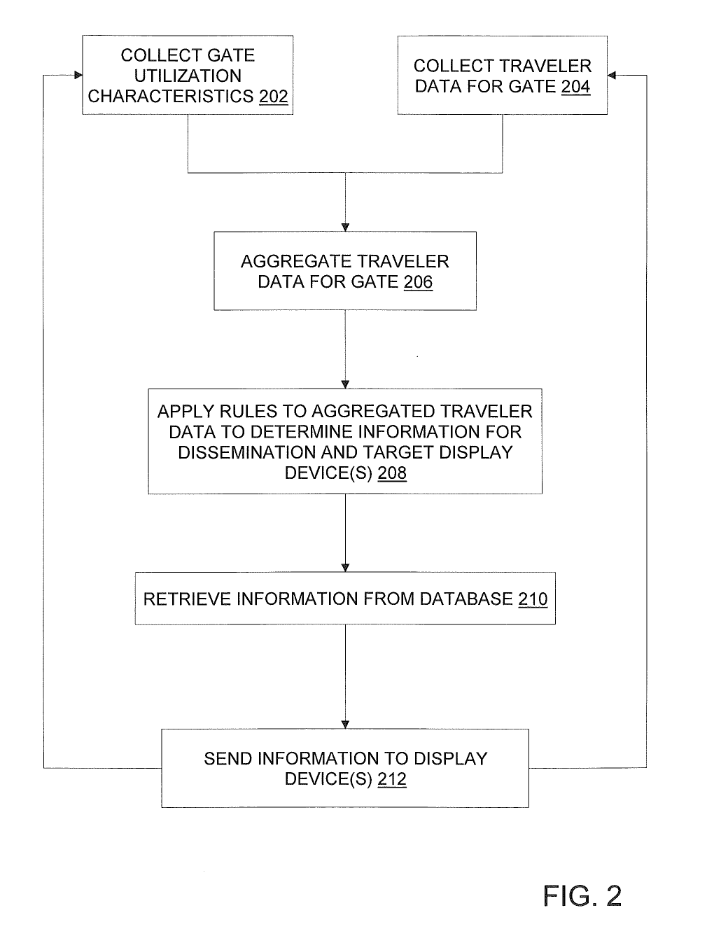

As indicated above, the targeted information processes utilize various sources of data to determine a selection of information for dissemination to a specific airport gate. The targeted information processes continually update collected gate utilization characteristics and traveler data, apply business rules to the data, and in conjunction with location-related information concerning various display devices, disseminate resulting information to selected display devices. Turning now to FIG. 2, a flow diagram describing an exemplary process for providing targeted information dissemination will now be described.

At step 202, the targeted information application 112 collects gate utilization characteristics. As indicated above, each gate at the airport may be assigned an identifier. The identifier is used by the airport personnel to create a flight schedule for each gate (arrivals and departures). The gate utilization characteristics may include arrival dates and locations and departure dates and locations. Once acquired, this information is stored as gate utilization characteristics in the storage device 110. As flight information often changes due to conditions, such as unplanned aircraft maintenance or weather, this gate utilization characteristics stored in storage device 110 may be updated periodically.

At step 204, the targeted information application 112 collects traveler data for the gate. The traveler data may be obtained from both the ticket purchasing system 104 and the passenger check in system 106. As indicated above, information may be gleaned from a transaction relating to an individual purchasing one or more tickets through the ticket purchasing system 104 (e.g., age, gender, frequent flyer mileage status, number of persons in the passenger's party, as well as their ages and gender). Additionally, the presence of the passenger at the airport may be determined from the passenger check in system 106 (i.e., the passenger intends to board the flight). Further, a number of pieces of baggage and the weight of these bags may be collected through the passenger check in system 106.

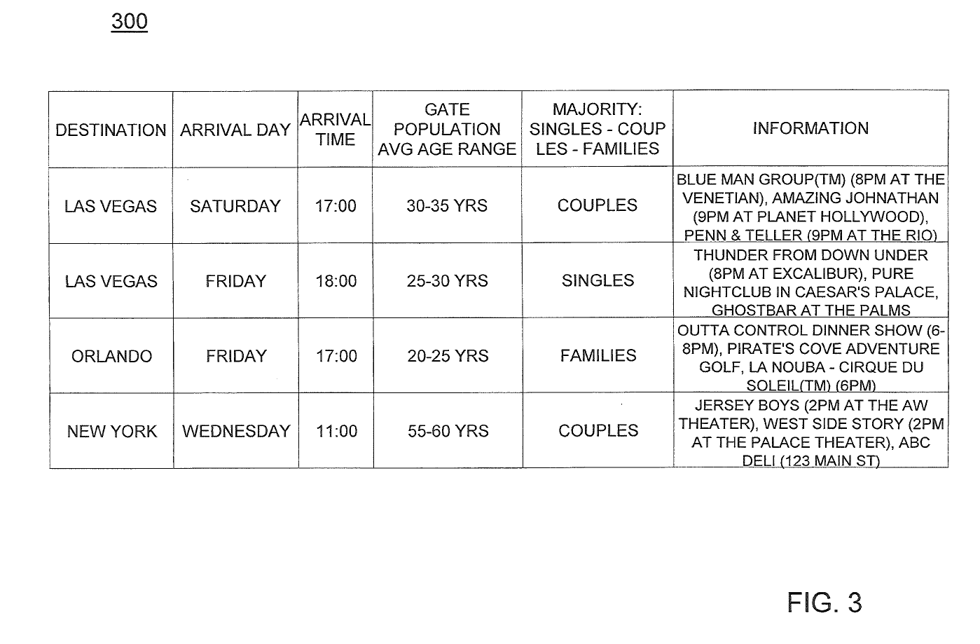

At step 206, the traveler data is aggregated for each gate and for each flight scheduled at the gate. The initial aggregation may be triggered, e.g., by an event such as the time that the gate is open for passengers traveling on a particular flight. Once aggregated, the information is analyzed to determine the existence of any patterns. The patterns may reflect a tendency of certain characteristics of passengers (e.g., family, couple, business, elderly, etc.). As shown, e.g., in FIG. 3, a table 300 illustrates four sample records, each referring to a particular flight at a gate. The traveler data aggregated reflects for the first record (Las Vegas, Arrival Day—Saturday) that the flight has been booked primarily by couples in the age range of 30-35 years.

At step 206, the targeted information application 112 applies rules to aggregated traveler data and gate utilization characteristics to determine what information will be selected for dissemination. In addition, the targeted information application 112 determines which of the display devices 208 will be used for displaying the disseminated information. In an exemplary embodiment, the targeted information application 112 may identify the vehicles currently servicing the gate (e.g., baggage vehicles, maintenance/repair vehicles, etc.) via the communication components 116 and networks 109.

At step 210, the targeted information application 112 retrieves the information to be disseminated from the information database 114. As indicated above, the information to be disseminated is determined by applying business rules to the aggregated traveler data and gate utilization characteristics. The targeted information application 112 determines the transmission addresses for the display devices 108 disposed on vehicles identified as being located at the gate, as well as the transmission address(es) for the display devices 108 installed at or near the gate.

At step 212, the targeted information application 112 transmits the information retrieved from step 212 to the designated display devices 108. As shown in FIG. 3, e.g., the information presented on the display devices 108 for the first record (Las Vegas, Arrival Day—Saturday) includes various shows scheduled for performance at the destination (Las Vegas) provided in the table 300.

In an exemplary embodiment, the processes described in FIG. 2 may be repeated continuously, e.g., while the gate is open for a particular flight. The number of travelers who check in at a particular gate will likely differ one hour before departure time as compared to thirty minutes before departure time, as more and more passengers tend to check in closer to the actual departure time. Likewise, the flight information for each flight may change at any time before the actual departure time, e.g., due to aircraft maintenance issues and/or weather concerns. In this embodiment, the information displayed in step 212 may be updated based upon changing populations of travelers arriving at the gate. For example, suppose the first information disseminated is targeted to couples between the ages of 30-35 based upon the current pattern recognized by the targeted information application 112. In this scenario, while the traveler data acquired for all booked seats of the flight indicates the majority of passengers are families with children under the age of 12, it may be that at the time of traveler data collection by the passenger check in system 106 (e.g., one hour before departure), only 10 passengers (5 couples) have checked in to the gate. Based upon this specific data, the information selected for dissemination may be geared toward adult entertainment and restaurants at the destination location. However, as the targeted information application 112 continuously updates the data collected (e.g., from step 212 to steps 202 and 204), the information selected for dissemination may change significantly based upon the newly collected data.

In an alternate embodiment, or in conjunction with the continuous updating of information above, the information may be presented on the display devices 108 for a time duration determined via the targeted information application 112. For example, the information may be presented on the display devices 108 installed at the gate until boarding of the flight has completed. Also, the information may be presented on the display devices 108 disposed on the servicing vehicles for as long as the communication elements indicate that the vehicles are located at the gate or until the flight has departed. It will be understood that the targeted information application 112 may be configured to display multiple selected information elements in sequence using the rules described above.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for implementing targeted information dissemination based on gate-specific utilization, comprising:
collecting gate-specific utilization characteristics for an airport gate, the airport gate having an association with at least display device;
collecting traveler data for the airport gate;
aggregating the traveler data;
identifying a pattern from aggregated traveler data, the pattern designated with an association with information for dissemination; and
disseminating the information to the at least one display device.

2. The method of claim 1, wherein the at least one display device is installed at the airport gate;
wherein disseminating the information includes retrieving a transmission address for the display device and transmitting the information to the display device installed at the airport gate.

3. The method of claim 2, wherein transmitting the information includes transmitting the information until aircraft boarding of passengers at the airport gate is completed, the traveler data collected for the airport gate corresponding to the passengers.

4. The method of claim 1, wherein the at least one display device is disposed on a transient vehicle that services the airport gate.

5. The method of claim 4, wherein disseminating the information includes determining the transient vehicle is located at the airport gate at a time of information transmission, retrieving a transmission address for the display device disposed on the transient vehicle, and transmitting the information to the display device on the transient vehicle via the transmission address.

6. The method of claim 5, wherein transmitting the information includes transmitting the information until an aircraft boarded by passengers at the airport gate has departed the airport gate, the traveler data collected for the airport gate corresponding to the passengers.

7. The method of claim 1, wherein the gate-specific utilization characteristics for the airport gate include flight schedule data.

8. The method of claim 1, wherein the traveler data includes at least one of passenger age;
passenger gender;
passenger frequent flyer miles;
data relating to passengers for which a passenger has purchased a ticket;
number of pieces of checked luggage; and
weight of the pieces of checked luggage.

9. A system for implementing targeted information dissemination based on gate-specific utilization, comprising:
a host system computer; and
an application executing on the host system computer, the application configured to implement a method, the method comprising:
collecting gate-specific utilization characteristics for an airport gate, the airport gate having an association with at least display device;
collecting traveler data for the airport gate;
aggregating the traveler data;
upon determining a time condition has been met:
identifying a pattern from aggregated traveler data, the pattern designated with an association with information for dissemination; and
disseminating the information to the at least one display device.

10. The system of claim 9, wherein the at least one display device is installed at the airport gate;
wherein disseminating the information includes retrieving a transmission address for the display device and transmitting the information to the display device installed at the airport gate.

11. The system of claim 10, wherein transmitting the information includes transmitting the information until aircraft boarding of passengers at the airport gate is completed, the traveler data collected for the airport gate corresponding to the passengers.

12. The system of claim 9, wherein the at least one display device is disposed on a transient vehicle that services the airport gate.

13. The system of claim 12, wherein disseminating the information includes determining the transient vehicle is located at the airport gate at a time of information transmission, retrieving a transmission address for the display device disposed on the transient vehicle, and transmitting the information to the display device on the transient vehicle via the transmission address.

14. The system of claim 13, wherein transmitting the information includes transmitting the information until an aircraft boarded by passengers at the airport gate has departed the airport gate, the traveler data collected for the airport gate corresponding to the passengers.

15. The system of claim 9, wherein the gate-specific utilization characteristics for the airport gate include flight schedule data.

16. The system of claim 9, wherein the traveler data includes at least one of:
passenger age;
passenger gender;
passenger frequent flyer miles;
data relating to passengers for which a passenger has purchased a ticket;
number of pieces of checked luggage; and
weight of the pieces of checked luggage.

17. A computer program product for implementing targeted information dissemination based on gate-specific utilization, the computer program product comprising a storage medium having instructions embodied thereon, which when executed by a computer cause the computer to implement a method, the method comprising:
collecting gate-specific utilization characteristics for an airport gate, the airport gate having an association with at least display device;
collecting traveler data for the airport gate;
aggregating the traveler data;
upon determining a time condition has been met:
identifying a pattern from aggregated traveler data, the pattern designated with an association with information for dissemination; and
disseminating the information to the at least one display device.

18. The computer program product of claim 17, wherein the at least one display device is installed at the airport gate;
wherein disseminating the information includes retrieving a transmission address for the display device and transmitting the information to the display device installed at the airport gate.

19. The computer program product of claim 18, wherein transmitting the information includes transmitting the information until aircraft boarding of passengers at the airport gate is completed, the traveler data collected for the airport gate corresponding to the passengers.

20. The computer program product of claim 17, wherein the at least one display device is disposed on a transient vehicle that services the airport gate.

21. The computer program product of claim 20, wherein disseminating the information includes determining the transient vehicle is located at the airport gate at a time of information transmission, retrieving a transmission address for the display device disposed on the transient vehicle, and transmitting the information to the display device on the transient vehicle via the transmission address.

22. The computer program product of claim 21, wherein transmitting the information includes transmitting the information until an aircraft boarded by passengers at the airport gate has departed the airport gate, the traveler data collected for the airport gate corresponding to the passengers.

23. The computer program product of claim 17, wherein the gate-specific utilization characteristics for the airport gate include flight schedule data.

24. The computer program product of claim 17, wherein the traveler data includes at least one of:
passenger age;
passenger gender;
passenger frequent flyer miles;
data relating to passengers for which a passenger has purchased a ticket;
number of pieces of checked luggage; and
weight of the pieces of checked luggage.
